(19) United States
(12) Patent Application Publication
(10) Pub. No.: US 2010/0270813 A1
(43) Pub. Date: Oct. 28, 2010

(54) METHOD AND ARRANGEMENT FOR FULLY AUTOMATIC FUNCTION CHECKING OF INTERNAL COMBUSTION ENGINES

(76) Inventors: Dipl.-Ing. Franz Roth, Altmannstein (DE); Karsten Baumhof, Kierspe (DE); Oliver Burgstahler, Aalen (DE); Norman Dix, Ingolstadt (DE)

Correspondence Address: Novak Druce & Quigg LLP, 300 New Jersey Ave, NW, Fifth Floor, Washington, DC, 20001, US

(21) Appl. No.: 12/670,240

(22) PCT Filed: Jun. 4, 2008
(86) PCT No.: PCT/EP2008/004465

§ 371 Date: Jun. 28, 2010

(30) Foreign Application Priority Data
Jul. 25, 2007 (DE) 10 2007 034 556.0

(51) Int. Cl. E05C 19/10; E05C 19/00

(52) U.S. Cl. 292/121; 292/95; 292/2

(57) ABSTRACT

In a locking device for the bonnet of a motor vehicle, a guide device is arranged on the bonnet, whereby an element of the lock that consists of the locking hook and clip is in engagement with the guide device, and whereby when the bonnet is closed and locked, the latter can be displaced relative to the locking hook and the clip via the guide device.

### BACKGROUND OF THE INVENTION

Known locking devices for the bonnet are in most cases arranged in the center and have a catch system with two locking stages. The second locking stage is used to prevent accidental opening of the bonnet in the event the first locking stage fails. The second locking stage is also used when the bonnet is unlocked from the passenger compartment and release of the second locking stage occurs from outside by a rocking activation.

The known locking devices are usually designed so that a locking hook engages behind a pin or a clip. To improve pedestrian protection in active bonnet systems, i.e., those systems in which the bonnet is moved backward to lift the leading edge of the bonnet, the pin or the clip would have to be made very long for the locking hook to always be engaged. Such a solution often cannot be implemented because of the structural conditions, since in the displacement of the bonnet, the parts of the locking device would collide with engine components that are arranged relatively high. If the second locking stage should be engaged, with the bonnet in the displaced position, a very high torque then develops in the area of the pin connection.

DE 10 2006 006 054 A1 discloses achieving a displacement of the bonnet backward and at the same time a setting up in the front area by means of appropriate shaping and positioning of the locking clip without additional actuating elements being necessary. For a greater front lift of the bonnet which is often necessary, longer displacement paths that would require an increasingly large locking clip are necessary.

When the locking clip is linearly guided, i.e., when the latter does not have any contour that effects setting up of the front edge of the bonnet, the guiding direction influences the inclination of the lock, which should correspond as precisely as possible to the direction of rotation, which is determined by the axis of rotation of the hinge.

The object of this invention is therefore to implement the bonnet without an additional actuating element and with reduced installation space while avoiding the above-mentioned drawbacks. To this end, the proven and known locking components, specifically a locking hook and a clip accommodating the hook, are to be used.

### SUMMARY OF THE INVENTION

The object is achieved in that a guide device is arranged on the bonnet, in that an element of the lock that consists of locking hooks and clips is in engagement with the guide device, and in that in the closed and locked bonnet, the latter can be moved via the guide device relative to the locking hook and the clip. As a result, the clip or the locking hook can be of conventional design. They only have to be provided with a sliding means, so that they are displaceable in the longitudinal direction on the guide device which is arranged on the bonnet. A great advantage of this arrangement consists in the fact that the locking position always remains the same independently of the displacement direction and the displacement position. The angular positions between the locking hook and the clip are not changed. When the bonnet is displaced backward, there is no collision between the locking hook or the clip/pin and the engine package. Nevertheless, the locking device can be activated in the customary way. It is thus easily possible to move the locking hook out from the second locking stage by pressing a rocker. Overall, a very compact system is achieved, which can be installed in the center and integral with the bonnet. Advantageously, the actuating element of the active hinge system that is present is used to move the bonnet backward even in the locking area.

The movement of the bonnet backward can not only be useful in connection with an improved pedestrian protection, but also when damage to the bonnet is to be avoided in a crash with another motor vehicle or a stationary obstacle up to a certain order of magnitude.

It is advantageous when the guide device that is arranged on the bonnet is designed and arranged in such a way that when the bonnet is moved backward, the front edge of the bonnet is simultaneously raised. Here, the guide device ensures linear guidance in the desired displacement direction. Here, also, the closed form of the clip prevents a slipping out of the locking hook from the clip when the bonnet is displaced. At the same time, it is achieved that the locking angle remains protected regardless of the displacement direction and the displacement position.

Under normal operation conditions, the clip that can be displaced along the guide device or the locking hook that can be displaced is secured by a locking mechanism. This locking mechanism is automatically released when the trunk lid is displaced backward by the actuating element. The locking mechanism can be implemented by, for example, a locking hook. It is especially advantageous when a spring element, which counteracts the movement of the bonnet, is provided. The locking mechanism and/or the spring element ensure that the starting position can be easily reproduced again after actuation of the system; thus, no parts have to be replaced.

In accordance with a design according to the invention, the clip can be displaceably arranged on the guide device, and the locking hook can be arranged permanently on a body component. This configuration is recommended in particular since during unlocking, in most cases the locking hook is pivoted and the activating element, for example a Bowden cable, can be more easily fastened on the body than on the movable bonnet.

As an alternative, it is of course possible to arrange the locking hook displaceably on the guide device and to fasten the clip permanently to a body component, e.g., to the front end.

Finally, the clip/the locking hook can be arranged on the guide device in such a way that when the bonnet is closed, the clip/the locking hook always strikes the corresponding component perpendicularly. This means that the clip/the locking hook is displaceably arranged on the guide device at an angle that corresponds to the displacement angle of the bonnet obliquely upward to the rear.

### BRIEF DESCRIPTION OF THE DRAWINGS

FIG. 1 shows the front part of a bonnet with a guide device secured thereto for the clip of a locking device for the bonnet,

FIG. 2 shows the arrangement from FIG. 1 with a bonnet that is displaced backward,

FIG. 3 shows an alternative design, in which the locking hook is displaceably accommodated in the guide device on the bonnet, and

FIG. 4 shows the arrangement from FIG. 3 in a bonnet that is displaced backward and obliquely upward.

### DETAILED DESCRIPTION OF THE PREFERRED EMBODIMENTS OF THE INVENTION

All depictions according to FIGS. Ito 4 show the front section of a bonnet 5, a guide device 7 that is arranged in the front end area thereof, and a locking device, which comprises a locking hook 9 and a clip 11 as essential components. In addition, other adjoining components, which are not referenced, specifically, a front body edge, a part of a front end, and the engine package, are shown.

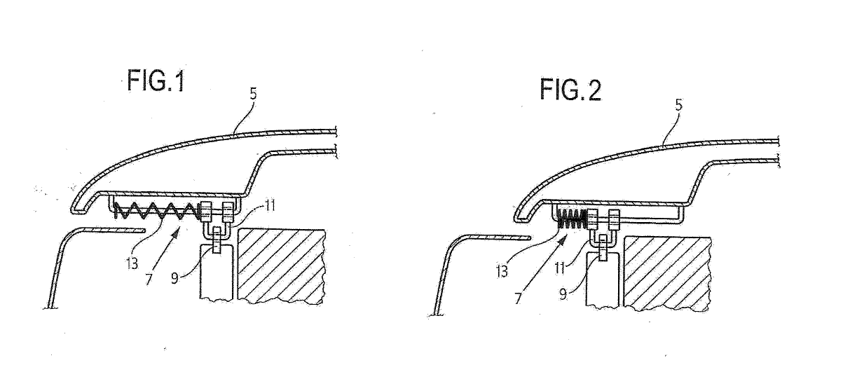

FIGS. 1 and 2 show a first embodiment, FIG. 1 depicting the starting position, i.e., the normal operating state, and FIG. 2 showing the conditions in the bonnet 5 that is displaced backward. According to this embodiment, the clip 11 is arranged in the guide device 7, so that it passes from the position shown in FIG. 1 to the position according to FIG. 2 when the bonnet is displaced backward. In addition to the frictional forces in the guide, only the force of a compression spring 13 counteracts this movement. During the entire displacement travel, the relationship between the locking hook 9 and clip 11, except for minor displacements of the locking hook 9 in the horizontal section of the clip 11, remains unchanged.

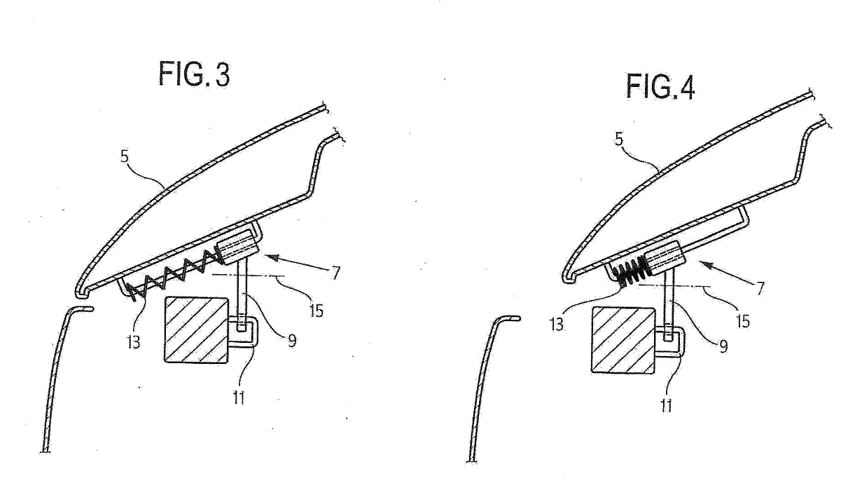

The embodiment shown in FIGS. 3 and 4 is distinguished from the embodiment described first in that not the clip 11, but rather the locking hook 9 can be displaced in the guide device 7. Furthermore, the displacement movement of the bonnet 5 occurs not only backward but also upward. Thus, in order to nevertheless keep the relationship of the locking angle, i.e., of the locking lever 5 to the clip 11 constant, the locking hook 9 is arranged at an angle on the guide device that corresponds to the displacement angle of the bonnet 5. The swivel axis of the locking hook 9 is indicated with the reference number 15.

1. A locking device for the bonnet of a motor vehicle, with a locking hook, a clip that accommodates the hook, and a device, by means of which the front edge of the bonnet can be displaced at least backward, wherein a guide device is arranged on the bonnet, in that an element of the lock that consists of the locking hook and clip is in engagement with the guide device, and wherein when the bonnet is closed and locked , the latter can be displaced via the guide device relative to the locking hook and the clip.

2. The locking device according to claim 1, wherein the guide device is designed and arranged in such a way that when the bonnet is moved backward, the front edge of the bonnet is simultaneously raised.

3. The locking device according to claim 1, wherein the movement of the bonnet backward counteracts a spring element.

4. The locking device according to claim 1 wherein the clip is displaceably arranged on the guide device, and the locking hook is arranged permanently on a body component.

5. The locking device according to claim 1 wherein the locking hook is displaceably arranged on the guide device, and the clip is arranged permanently on a body component.

6. The locking device according to claim 1 wherein the clip/the locking hook are arranged on the guide device in such a way that when the bonnet is closed, the clip/the locking hook always strikes the corresponding component perpendicularly.

7. The locking device according to claim 1 wherein the clip and the locking hook also remain engaged after the locking device is triggered.

8. A locking device for the bonnet of a motor vehicle comprising:
a guide device mounted on the underside of said bonnet, including a guide rod disposed in a longitudinal plane;
a follower mounted on and displaceable along said guide rod;
means connecting said follower to a portion of the body of said vehicle; and
a spring disposed between said follower and a portion of said guide device secured to said bonnet for biasing said bonnet longitudinally to a rest position.

9. A locking device according to claim 8 wherein said connecting means is disposed perpendicularly to said follower.

10. A locking device according to claim 9 wherein said follower is swivable relative to said connecting means about a longitudinally disposed axis.

11. A locking device according to claim 9 wherein said follower means is disposed at an acute angle relative to said connecting means.

12. A locking device according to claim 11 wherein said follower is swivable relative to said connecting means about a longitudinally disposed axis.
